(19) United States
(12) Patent Application Publication
(10) Pub. No.: US 2004/0130633 A1
(43) Pub. Date: Jul. 8, 2004

(54) Portable digital image and sound recording device of structural improvement

(76) Inventor: Wen-Tsung Liu, Hsin-Dian City (TW)

Correspondence Address: TROXELL LAW OFFICE PLLC, SUITE 1404, 5205 LEESBURG PIKE, FALLS CHURCH, VA, 22041, US

(21) Appl. No.: 10/434,226

(22) Filed: May 9, 2003

(30) Foreign Application Priority Data
Jan. 8, 2003 (TW) 092200307

(51) Int. Cl. H04N 5/76

(52) U.S. Cl. 348/231.4; 348/231.9

(57) ABSTRACT

A portable digital image and sound recording device of structural improvement comprising: a main body and a control unit; wherein a transfer interface is installed in or connected with the main body at a proper position for transferring data, a control unit is set inside main body and connected with the transfer interface for transferring the recorded data of main body to external storage device to be stored as backup data.

### THE SCOPE OF THE INVENTION

The present invention is a portable digital image and sound recording device of structural improvement and in particularly a design of storing the data in external storage as backup data that is recorded by a portable digital image and sound recording device by the control unit.

### THE BACKGROUND OF THE INVENTION

With the development of science, the general consuming electronic devices have come into digital time. The products of portable digital image and sound recording device such as digital camera, digital video camera, PAD or mobile phone etc., have come into people's life. This kind of portable digital image and sound recording device mainly comprises main body, a control electronic circuit, a display unit, a storage unit, a transfer interface, and a control unit allowing it to digitalize the image, animation, music or other data. However, due to concerning about saving power and reducing configuration, the general portable digital image and sound recording devices take advantage of installing Flash memory or Flash memory technology to develop changeable memory cards as their storage units to record data; under concerning of the cost of manufacturing and economy, the capacity of the storage unit of portable digital image and sound recording device is about 16-128 MB, it can be accepted by public. Yet, the number of multimedia data that the existed portable digital image and sound recording device needs to process tends to increase dramatically, it has resulted in insufficiency of storage capacity and inconvenience for user. For effectively solving these problems, the means to zip multimedia data by using software has been taken and greatly decreased the number of data storage, whereas, the capacity of storage unit of portable digital image and sound recording device can not satisfy user's needs to perform the operation of storing numerous multimedia data, and user has to buy electronic memory cards with higher storage capacity or multiple memory cards to serve as storage, or has to delete the recorded data from the storage unit for re-recording, or move the recorded data into computer for re-using, these problems as described above cause confusion and inconvenience. Although the technology and its disadvantages of prior design of portable digital image and sound recording device has been disclosed above, there are still many aspects have not been concerned; for example,

The portable digital image and sound recording device cannot transfer the recorded data to external storage device (Such as: hard disc driver) with high capacity for recording and storing data by its transfer interface, the other devices (Such as: computer mainframe) must be used to transfer the data that is recorded inside the portable digital image and sound recording device to external storage device.

1. Whether the portable digital image and sound recording device can be designed to directly transfer the recorded data to external media storage.

2. Whether the portable digital image and sound device an be designed to have more than one transferring interface allowing to support the external media storages with different interface so as to provide more options to user.

There are some improvements can be done due to the disadvantages of the existed portable digital image and sound recording device as described above, thus the inventor created this invention to overcome the disadvantages of such portable digital image and sound recording devices.

### THE PURPOSE OF THE INVENTION

The main purpose of this invention is to provide a portable digital image and sound recording device of structural improvement to transfer the data that is recorded in the device to external storage media as backup data by the control unit.

To achieve the goals as above, the present invention provides a portable digital image and sound recording device of structural improvement, it comprises: a main body with a transferring interface which can connect with an external storage device on proper position and allowing main body to transfer data between itself and storage device; a control unit is installed inside main body and is used to make the portable digital image and sound recording device be a host machine in order to transfer the recorded data to the external storage media.

Another purpose of this invention is that the transferring interface can be USB, IEEE1394, PCMCIA, Serial ATA, IDE, CF or other transferring interface to provide multiple utilizations of transferring interface to user. It will be better to understand the detailed structure, principle, and features of this present invention according to the descriptions of accompanying drawings.

### THE DESCRIPTION OF THE PREFERRED EMBODIMENT

Referring to the FIG. 1, the present invention of the portable digital image and sound recording device of structural improvement can be digital camera, digital video camera, mobile phone with the feature of image and sound recording or other digital electronic products with the feature of image and sound recording. It comprising: a main body 1 with an interface 11 on its proper position for connecting with an external device 2 and transferring data, also there are control circuit, display unit, storage unit and operation unit etc., these units' structural characters and features have been known by practitioners in the art.

### THE MAIN CHARACTERS OF THE INVENTION

The main body 1 includes a control unit 12 for controlling the data transfer, data record between the portable digital image and sound recording device of structural improvement and external device, and making it possible to allow main body 1 to transfer recorded data directly to external storage device without other host devices or instruments so as to have preferable advantages.

In the present invention, the means that the main body 1 connects with storage device 2 can be integrated or separate, also the storage media 2 may be a storage device with high capacity (such as: hard disc driver), and a power unit can be set inside storage media 2 to provide self-power without providing power by main body 1 so that the power using time of main body 1 increases dramatically.

According to the preferred embodiment of the invention, the interface 11 can be designed as having more than one transferring interface, wherein the transferring interface may be USB, IEEE1394, PCMCIA, Serial ATA, IDE, CF etc. so as to provide a convenient utilization of transferring interface to user. Therefore, the present invention has multiple utilizations.

Also, the storage media 2 in this invention is hard disc, CD, MO or ZIP etc.

To sum up, the present invention of portable digital image and sound recording device of structural improvement can truly realize the desired features and has distinctive improvements on structure and utilizations when compares with the traditional portable digital image and sound recording device. Further, this present invention never be published and taken use, so it satisfies the criterion for novelty. This application is proposed according to related acts, it will be appreciated if this invention is granted paten right.

However, the description as above is only one of the preferred embodiments of the present invention, any modification according to the spirit of the invention resulting in the functional changes of these devices is the equal alternatives covered by the description and accompany drawing, and should not exceed the scope of the invention.

### BRIEF DESCRIPTION OF THE DRAWING

FIG. 1 is a perspective view of the present invention.

1. Main body

2. Storage unit

11. Transferring interface

12. Control unit

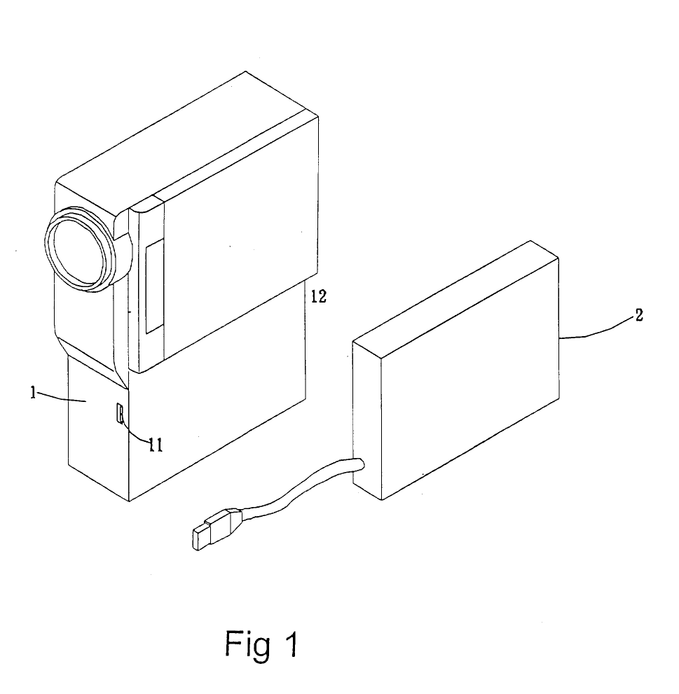

1. The representative drawing is: FIG. 1

2. The brief explanation of the components of the representative drawing:

1. Main Body

2. Storage Media.

11. Transfer Interface

12. Control Unit

What is claimed is:

1. A portable digital image and sound recording device according to structural improvement comprising: a main body with a transferring interface that can connect with an external storage device on proper position allowing main body to transfer data; preferably, a control unit that connects with transferring interface is set in the main body and controls the performance of directly transferring data and recording data from the portable digital image and sound recording device to external storage device.

2. The portable digital image and sound recording device of structural improvement according to claim 1 wherein the transferring interface is one of USB, IEEE1394, PCMCIA, Serial ATA, IDE, or CF.

3. The portable digital image and sound recording device of structural improvement according to claim 1 or 2 wherein the transferring interface can be designed as having more than one interface so as to provide a convenient utilization of transferring interface to user. Therefore, the invention has multiple utilizations.

4. The portable digital image and sound recording device of structural improvement according to claim 1 wherein the external storage device has a power unit to provide self-power.

5. The portable digital image and sound recording device of structural improvement according to claim 1 wherein the external device can be a hard disc driver with high capacity.

6. The portable digital image and sound recording device of structural improvement according to claim 1 wherein the external storage device may be CD, MO or ZIP module etc.
